(19) United States
(12) Patent Application Publication
(10) Pub. No.: US 2010/0245384 A1
(43) Pub. Date: Sep. 30, 2010

(54) DISPLAY APPARATUS, DISPLAY MODE DETERMINATION METHOD AND RECORDING MEDIUM HAVING A DISPLAY PROCESSING PROGRAM RECORDED THEREIN

(75) Inventor: Kenichi MASE, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/730,715

(22) Filed: Mar. 24, 2010

(30) Foreign Application Priority Data
Mar. 31, 2009 (JP) 2009-087908

(51) Int. Cl. G06F 3/041; G09G 5/00

(52) U.S. Cl. 345/618; 345/173

(57) ABSTRACT

Contamination level at positions on a display screen is determined based on contact information containing information about a contact action detected by a contact detection section, which is disposed on the display screen to detect the contact action, and information about the contact position on the display screen, and a characteristic portion of the image is extracted. A display mode for the characteristic portion as extracted is determined based on the contamination level as determined.

### CROSS REFERENCE TO RELATED APPLICATION

The present application claims priority from Japanese Patent Application No. 2009-87908, which was filed on Mar. 31, 2009, the disclosure of which is incorporated herein by reference in its entirety.

### BACKGROUND OF THE INVENTION

1. Field of the Invention

The present invention relates to a technical field of a display apparatus having a touch panel display.

2. Related Art

A display apparatus having a touch panel display has been applied for example to a portable game machine, a mobile phone, a car navigation apparatus and the like, thus having widely been used.

A touch panel display enables a user to make an intuitive operation. This display may cause a display screen to become large. However, the user directly touch the display screen of the touch panel display, with the result that contamination and scuff may decrease transmissivity and deteriorate an external appearance, thus causing problems.

In order to solve the above-describe problems, there has been proposed to apply an art wherein respective position coordinates of contact areas of a touch panel on which various operation keys are designed to be disposed, and a frequency of the contact action are stored and a button position of the operation key is changed to shift so that overlap of the coordinate having a high frequency of the contact action with the button position of the operation key becomes minimum. This may provide an effect as expected that a partial deterioration of the display screen can be avoided and contamination such as dirt from a finger can be scattered.

### SUMMARY OF THE INVENTION

However, in the above-described art, the operation key having a high frequency of the contact action is merely shifted, and there is no consideration of a case of display of an image, etc., wherein a portion having a high frequency of the contact action may overlap with a characteristic portion of an image (for example, a face of a character, etc.), thus not providing a full improvement in visibility of the characteristic portion of the image.

An object of the present invention, which has been made in view of the above-described problems, is to provide a display apparatus, a display mode determination method and a recording medium having a display processing program recorded therein, which permit to improve fully visibility of the characteristic portion of the image and enable a user to use them in a comfortable manner for a long period of time.

In order to attain the aforementioned object, a display apparatus according to a first aspect of the present invention comprises: a display screen on which an image is to displayed, and a contact detection device disposed on the display screen to detect a contact action, wherein:

said display apparatus further comprises:

a contact information storage device that stores contact information comprising information about the contact action detected by said contact detection device and information about a position on said display screen;

a contamination level determination device that determines a contamination level at a plurality of positions on said display screen, based on the contact information stored in said contact information storage device;

an image characteristic portion extraction device that extracts a characteristic portion of said image; and

a display mode determination device that determines a display mode for the characteristic portion extracted by said image characteristic extraction device, based on the contamination level at the plurality of positions on said display screen, which has been determined by said contamination level determination device.

A method according to a second aspect of the present invention for determining a display mode in a display apparatus comprising a display screen on which an image is to displayed, and a contact detection device disposed on the display screen to detect a contact action, said method comprises the steps of:

storing contact information comprising information about the contact action detected by said contact detection device and information about a position on said display screen;

determining a contamination level at a plurality of positions on said display screen, based on the contact information as stored;

extracting a characteristic portion of said image; and

determining a display mode for the characteristic portion as extracted, based on the contamination level as determined at the plurality of positions on said display screen.

A recording medium according to a third aspect of the present invention has a display processing program recorded therein, which is to be executed by a computer comprising a display screen on which an image is to displayed, and a contact detection device disposed on the display screen to detect a contact action, to cause the computer to function as:

a contact information storage device that stores contact information comprising information about the contact action detected by said contact detection device and information about a position on said display screen;

a contamination level determination device that determines a contamination level at a plurality of positions on said display screen, based on the contact information stored in said contact information storage device;

an image characteristic portion extraction device that extracts a characteristic portion of said image; and

a display mode determination device that determines a display mode for the characteristic portion extracted by said image characteristic extraction device, based on the contamination level at the plurality of positions on said display screen, which has been determined by said contamination level determination device.

### BRIEF DESCRIPTION OF THE DRAWINGS

FIG. 1 is a view illustrating a schematic configuration example of a display apparatus with a touch panel according to the embodiment of the present invention;

FIG. 2 is a view illustrating an example of contact information stored in a contact information database 21;

FIG. 3(A) is a view illustrating an example of distribution of contact pressure applied by a finger;

FIG. 3(B) is a view illustrating an example of distribution of contact pressure applied by a pen;

FIG. 4(A) is a view illustrating an example of a characteristic region extracted as a characteristic portion from an image;

FIG. 4(B) is a view illustrating an example of a central portion of the characteristic region extracted as a characteristic portion from an image;

FIG. 5 is a view illustrating an example of the respective contamination levels of blocks on a display screen 11;

FIG. 6 is a flowchart showing an example of processing in a control unit 3 of the display apparatus “S” with the touch panel according to the embodiment of the present invention;

FIG. 7(A) is a schematic view illustrating an example wherein the characteristic region of the image is displayed at a predetermined position in Example No. 1;

FIG. 7(B) is a schematic view illustrating an example wherein the position for display of the characteristic region of the image has been changed in Example No. 1;

FIG. 8 is a flowchart showing a display mode determination processing in Example No. 1;

FIG. 9(A) is a schematic view illustrating an example wherein the central portion of the characteristic region of the image is displayed at a predetermined position in Example No. 2;

FIG. 9(B) is a schematic view illustrating an example wherein the position for display of the central portion of the characteristic region of the image has been changed in Example No. 2;

FIG. 10 is a flowchart showing a display mode determination processing in Example No. 2;

FIG. 11(A) is a schematic view illustrating an example wherein the central portion of the characteristic region of the image is displayed at a predetermined position in Example No. 3;

FIG. 11(B) is a schematic view illustrating an example wherein the position for display of the central portion of the characteristic region of the image has been changed in Example No. 3;

FIG. 12 is a flowchart showing a display mode determination processing in Example No. 3;

FIG. 13(A) is a schematic view illustrating an example wherein the characteristic portions are displayed at respective predetermined positions in Example No. 4;

FIG. 13(B) is a schematic view illustrating an example wherein the positions for display of the characteristic portions are changed in Example No. 4;

FIG. 13(C) is a schematic view illustrating an example wherein the positions for display of the characteristic portions are further changed in Example No. 4;

FIG. 14 is a flowchart showing a display mode determination processing in Example No. 4; and

FIG. 15 is a schematic view illustrating an example wherein an image having the characteristic portion is turned in Example No. 5.

### DESCRIPTION OF THE PREFERRED EMBODIMENTS

Now, the embodiments of the present invention will be described below with reference to the drawings. In the embodiments of the present invention as described below, the present invention is applied to a display apparatus with a touch panel display (hereinafter referred to as the “display apparatus with touch panel”.

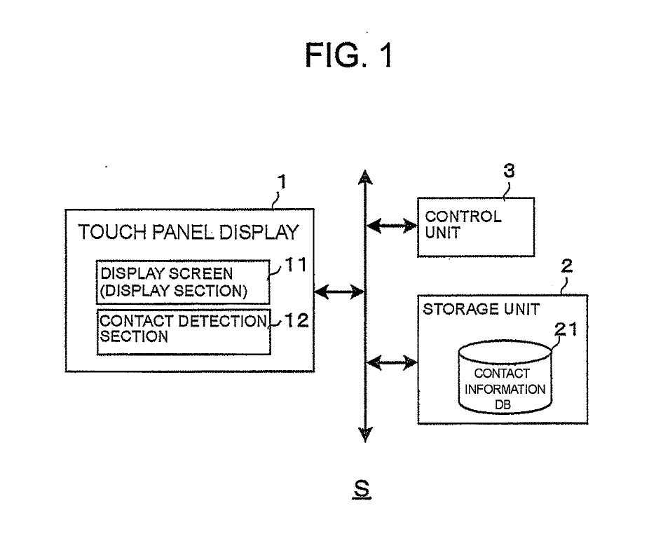

First, the structure and function of the display apparatus with touch panel according to the embodiment of the present invention will be described with reference to FIG. 1, etc.

As shown in FIG. 1, the display apparatus with touch panel “S” is provided with a touch panel display 1, a storage unit 2 and a control unit 3, etc.

The touch panel display 1 has a display screen (display section) 11 and a contact detection section 12 serving as a contact detection device that is disposed on the display screen 11 to detect a contact action.

Images and operation buttons to input various operation instructions from a user are displayed on the display screen 11 under the control of the control unit 3.

The contact detection section 12 detects a contact action on the display screen 11, given by a user through his/her finger or a pen, etc., and then outputs a positional information indicative of a contact position on the display screen 11 to the control unit 3. The positional information includes information indicative of coordinates (X, Y) on the display screen 11. A contact portion of the display screen 11, to which the user comes into contact, actually has a certain area, and the positional information outputted to the control unit 3 may include information indicative of a cluster of points each having coordinates. The number of points in the above-mentioned cluster in the case where a user touches the display screen 11 with his/her finger is different from that in the case where a user touches it with a pen other than the finger (more specifically, it may vary depending upon a kind of a thing, which comes into contact with the display screen).

The contact detection section 12, which is provided with a piezoelectric element to convert a force into a voltage, outputs pressure information indicative of a contact pressure at a contact position on the display screen 11, together with the above-described positional information to the control unit 3. Distribution of differences in contact pressure at the respective points in the above-mentioned cluster in the case where a user touches the display screen 11 with his/her finger is different from that in the case where a user touches it with a pen other than the finger (more specifically, it may vary depending upon a kind of a thing, which comes into contact with the display screen).

The storage unit 2, which is composed for example of an nonvolatile semiconductor memory (e.g., a flash ROM), a hard-disk drive unit or the like, stores, an OS (operating system), an image display program of the present invention, an application program and various kinds of predetermined data. The application program may include for example a slide show program, which controls display processing for a slide show in which images are displayed at a predetermined interval, while switching the images.

In addition, the storage unit 2 stores image data for images to be displayed on the display screen 11 (e.g., an image file in TIFF, GIF or JPEG format).

Further, the storage unit 2 has a contact information database (DB) 21 for the contact information (i.e., an example of a contact information storage device).

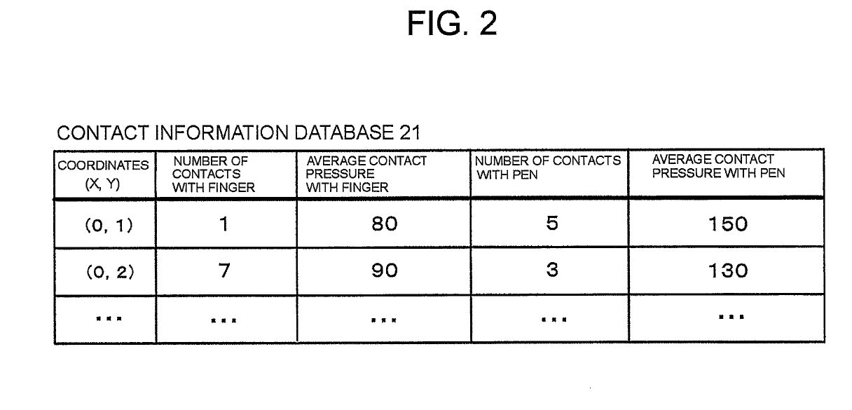

In an example as shown in FIG. 2, there are stored, as the contact information, the number of contacts with a finger, an average contact pressure by a finger (an average of pressures in a plurality of contacts), the number of contacts with a pen, an average contact pressure by the pen, etc.

Both of the number of contacts and the contact pressure are described in the example as shown in FIG. 2 as being stored as the contact information. However, any one of them may be stored. In addition, the number of contacts and the average contact pressure are described as being stored in each case of a thing, which comes into contact with the display screen (in the example, the finger or the pen). However, they may be stored irrespective of a kind of the thing, which comes into contact with the display screen.

The control unit 3 is provided with a CPU, a RAM, a ROM, etc., and the CPU may function, during execution of an OS, not only as a display control device and an operation control device based on the programs (including the application programs and the display processing program of the present invention) stored in the ROM or the storage unit 2, but also as an image characteristic portion extraction device, a contamination level determination device, a display mode determination device, a threshold judgment device, a retrieval device, a continuous-blocks region detection device, a largest-characteristic region detection device, a region detection device, a contact object kind recognition device, a weighting determination device, a distance calculation device, a cleaning mode detection device and a contamination initialization device of the present invention.

More specifically, the control unit 3, which serves as the display control device, outputs image data, etc. to the touch panel display 1 to display the image corresponding to the above-mentioned image data on the display screen 11, and make a display control to display the various kinds of operation buttons at the predetermined positions on the display screen 11.

The control unit 3, which serves as the operation control device, executes, when a user touches the operation button displayed at the predetermined position on the display screen with his/her finger or by a pen (i.e., giving an operation instruction) to input the positional information and the pressure information as outputted from the contact detection device 12, a processing corresponding to the operation instruction associated with the above-mentioned positional information (e.g., a displayed image change processing, a creation processing of a slide show, a start or end processing of the slide show, an image switching processing during the slide show, a cleaning mode processing, etc.).

In addition, the control unit 3 to which the positional information and the pressure information as outputted from the contact detection device 12 have been inputted, identifies the contact information corresponding to the coordinates of the contact position, which are indicated by the above-mentioned positional information, from the contact information database 21 and updates the contact information as identified. For example, the control unit 3 increments the number of contacts included in the contact information as identified, by one to update (overwrite) that number of contacts, and then calculates a new average contact pressure from the average contact pressure included in the above-mentioned contact information and the contact pressure indicated by the above-mentioned pressure information to update the average contact pressure. The contact information stored in the above-mentioned contact information database 21 is updated in this manner, every time the positional information is inputted from the contact detection device 12 to the control unit 3. In the case where the above-mentioned positional information includes information about the cluster of points having the coordinates, the contact information about all the points having the coordinates in the cluster (this may be the coordinates in the vicinity of the central portion or the coordinates in which the contact pressure is higher than the threshold) is specified for example from the contact information database 21 to be updated.

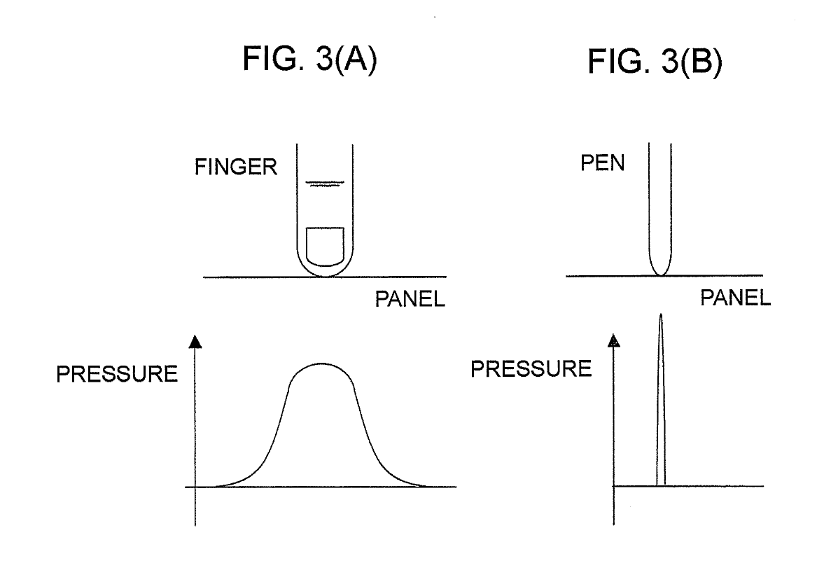

In the case where the number of contacts and the average contact pressure are classified based on a kind of contact object as shown in FIG. 2, the number of contacts (the number of contacts with a finger and the number of contacts with a pen in the example as shown in FIG. 2) and the average contact pressure (the average contact pressure applied by a finger and the average contact pressure applied by a pen in the example as shown in FIG. 2) are calculated and the average contact pressure is updated. In this case, the control unit 3 recognizes the kind of the contact object as detected by the contact detection section 12, based on at least one of the positional information and the pressure information as inputted. In the case where the number of points having the coordinates in the cluster, which are included in the positional information as inputted exceeds a reference value as previously set (in other words, has a larger contact area), the control unit 3 recognizes a kind of the contact object as a finger, and on the other hand, in the case where the number of points is equal to or less than the above-mentioned reference value, the control unit 3 recognizes a kind of the contact object as a pen. Alternatively, in the case where the contact pressure as indicated by the pressure information as inputted is for example equal to or less than a reference pressure as previously set, the control unit 3 recognizes the kind of the contact object as a finger, and on the other hand, in the case where the contact pressure exceeds the reference pressure, the control unit 3 recognizes a kind of the contact object as a pen. As is clear from FIG. 3, contact with the finger and contact with the pen are different from each other in their area and expansion, thus making it possible for the control unit 3 to recognize as to which of the finger and the pen is the contact object.

The control unit 3 serving as the image characteristic portion extraction device extracts the characteristic portion of the image displayed on the display screen 11. The control unit 3 extracts the characteristic region (i.e., a region, which is composed of a plurality of pixels) including for example an image of a face of a person, as the characteristic portion on the basis of a known object recognition algorism or an edge extraction algorism, or extracts a central portion of the above-mentioned characteristic region (e.g., a region having the coordinates of the central portion of the characteristic region or a region including the central portion and its surrounding region), as the characteristic portion.

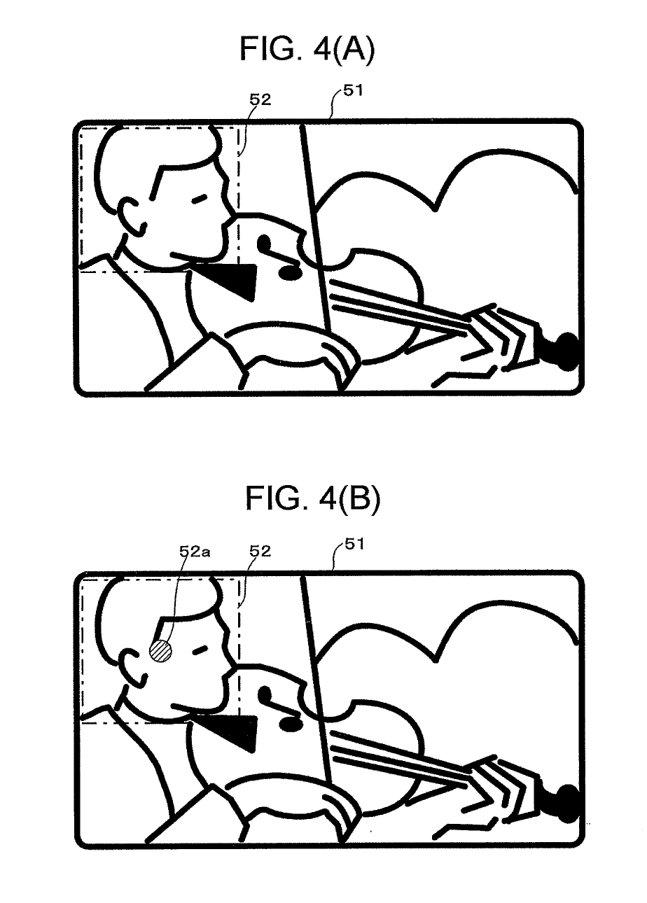

A single characteristic portion is extracted in the example as shown in FIG. 4. However, the plurality of characteristic portions may be extracted.

The control unit 3 serving as the contamination level determination device determines the contamination level at a plurality of positions including the position for display of the above-mentioned characteristic portion on the display screen 11, based on the contact information corresponding to the respective coordinates stored in the contact information database 21. The control unit 3 determines for example the contamination level in pixel on the display screen 11 or in a unit of blocks into which the display screen 11 (display region) is divided.

The “contamination level” is a parameter indicative of a degree of deterioration of visibility of an image displayed on the display screen 11. Visibility of the image deteriorates with increased contamination level. For example, contamination and scuff on the display screen 11 are considered as factors deteriorating visibility of the image.

In the case where the contamination level is determined in a pixel unit, the control unit 3 determines the contamination level for the respective pixel, based on at least one of the number of contacts and the average contact pressure, as included in the contact information corresponding to the respective points having the coordinates, as stored in the contact information database 21. For example, the number of contacts is determined as the contamination level. In this case, the contamination level increases with the increased number of contacts in the position of pixel on the display screen 11. Alternatively, the average contact pressure may be determined as the contamination level. In this case, the contamination level increases with the increased average pressure in the position of pixel on the display screen 11. The sum or the product of the number of contacts and the average contact pressure may be determined as the contamination level. The contamination level in the pixel as determined in this manner is stored for example in the storage unit 2 (the contamination level may be stored in the contact information database 21).

In the case where the number of contacts and the average contact pressure are classified based on a kind of contact object as shown in FIG. 2, the control unit 3 may determine, as the contamination level, for example the sum of the number of contacts with a finger and the number of contacts with a pen or the sum of the average contact pressure applied by a finger and the average contact pressure applied by a pen. In this case, the control unit 3 may be configured to determine weighted values of the contamination levels in accordance with a kind of the contact object and determine the contamination level at the positions of respective pixels based on the weighted values as determined in this manner, thus making it possible to determine a more appropriate contamination level in accordance with the kind of the contact object. In an example, the control unit 3 determines the weighted value of the contamination level for a finger as “G1” (for example, 0.6) and determines the weighted value of the contamination level for a pen as “G2” (for example, 0.4). Then, the control unit 3 determines, as the contamination level, the sum of the “number of contacts with a finger×G1” and the “number of contacts with a pen×G2”, or the sum of the “average contact pressure applied by a finger×G1” and the “average contact pressure applied by a pen×G2”.

Alternatively, the control unit 3 may be configured to calculate a value corresponding to a distance between the position for display of the characteristic portion on the display screen 11 and a position for display of a thing other than the characteristic portion on the display screen 11 (this may be a distance or the number of pixels), determine weighted values of the contamination levels at the other positions than the characteristic portion on the display screen 11, and determine the contamination level at the points having the respective coordinates, thus making it possible to determine a more appropriate contamination level in accordance with the distance. On the assumption that a value corresponding the distance between the position for display of the characteristic portion on the display screen 11 and the farthest position therefrom on the display screen 11 is “Dmax”, the control unit 3 determines the weighted value of the contamination level “G” as “G=D/Dmax”. More specifically, the weighted value of the contamination level becomes larger with the increased value “D” according to the distance. The control unit 3 then determines the “number of contacts×G” or the “average contact pressure×G” as the contamination level. According to such specific features, the farthest position from the position for display of the characteristic portion on the display screen 11 provides a larger contamination level, even if the number of contacts is the same for example. Therefore, it is possible to reduce an amount of shift of the image (i.e., an amount of shift from the initial position) as much as possible, when moving the position for display of the characteristic portion to a position on the display screen 11, in which the contamination level is equal to or less than the threshold, as described later.

In the case where the contamination level is determined in a block unit, the control unit 3 determines the contamination level in each of the blocks based for example on the contact information for each of the pixels included in the block (i.e., at least one of the number of contacts and the average contact pressure). For example, the accumulated amount of contamination levels for the positions of respective pixels included in the respective block may be determined as the contamination level for the position of respective block, based on the contamination level for the respective pixels as determined as described above. The contamination level as determined in a block unit is stored for example in the storage unit 2. Utilization of the contamination level in a block unit permits to retrieve promptly a contaminated region and a non-contaminated region.

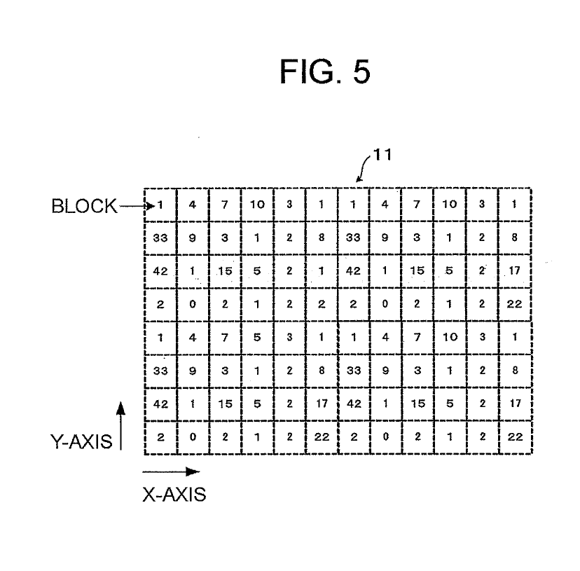

FIG. 5 shows an example in which the display screen 11 is divided into 8×12 blocks and respective numerical values indicated on the brocks denote the contamination level. In FIG. 5, the block with the larger numerical number shows the higher contamination level.

The control unit 3, which serves as the display mode determination device, determines the display mode for the characteristic portion of the image as extracted, on the basis of the contamination level at the plurality of positions as determined as described above on the display screen 11. The control unit 3 determines, for example, the display mode for the above-mentioned characteristic portion so that the characteristic portion of the image is displayed at a position having the low contamination level on the display screen 11. This makes it possible to improve effectively visibility of the characteristic portion of the image to be displayed on the display screen 11, thus enabling a user to use the display apparatus in comfortable condition for a long period of time, even if the display screen 11 is contaminated.

The control unit 3, which serves as the display control device, displays the image having the characteristic portion, based on the display mode for the characteristic portion of the image as determined.

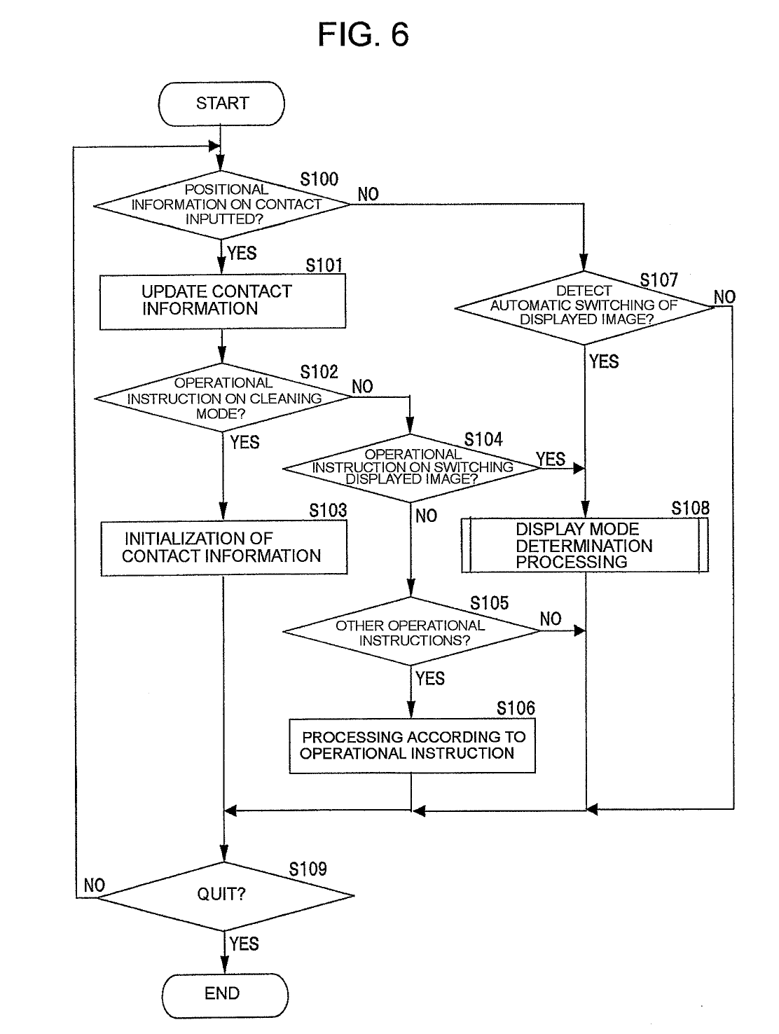

Now, description will be given below with reference to FIG. 6, etc., of operation of the display apparatus with touch panel “S” according to the embodiment of the present invention, configured as described above.

The processing as shown in FIG. 6 is started for example by powering on the display apparatus with touch panel “S”. This also starts the display processing for example for a slide show.

First, in Step S100, the control unit 3 judges as whether or not there have been inputted the positional information and the pressure information about contact outputted from the contact detection device 12 through detection of contact by the contact detection device 12 (e.g., an operational instruction by a user). In the case where the positional information, etc., have been inputted (YES in Step S100), the system moves to Step S101. In the case where, the positional information, etc., have not as yet been inputted (NO in Step S100), the system moves to Step S107.

Then, in Step S101, the control unit 3 identifies the contact information corresponding to the coordinates of the contact position, which are indicated by the positional information as inputted, from the contact information database 21 and updates the contact information as identified as described above, and then the system moves to Step S102. In this step, the control unit 3 may determine the contamination level in a pixel unit or a block unit on the display screen 11 and cause this information to be stored in the storage unit 2.

Then, in Step S102, the control unit 3 judges as whether or not the contact as detected by the contact detection device 12 has been made on the basis of an operational instruction on a cleaning mode for cleaning the display screen 11. In the case where, fore example, an icon, which is indicative of the cleaning mode, is displayed on the display screen 11 and a user touches this icon, the control unit 3 detects the cleaning mode. In the case where the contact has been made on the basis of the operational instructions on the cleaning mode (i.e., the cleaning mode is detected) (YES in Step S102), the control unit 3 causes the system to move to Step S102. In the case where the contact has not been made on the basis of the operational instructions on the cleaning mode (NO in Step S102), the control unit 3 causes the system to move to Step S104. When the system moves into this cleaning mode, the control unit 3 changes the color of the whole display screen 11 to the initial color in which an user may easily recognize visibly the contamination such as fingerprints. When the user wipes the display screen 11 with a cloth, the contact detection device 12 detects the contact caused by the wiping action, and then the control unit 3 causes, after recognition of this contact, the color of a part as wiped of the display screen 11 to a different color from the initial color, which is indicative of completion of the cleaning. This change in display enables the user to recognize the part as wiped at a glance.

In Step S103, the contamination on the display screen 11 is cleaned in the cleaning mode, and the control unit 3 resets (clears) the contact information stored in the contact information database 21 and causes the system to move to Step S109. In the case where the contamination level as already determined is stored in the storage unit 2, this contamination level is also reset. This permits to determine newly the contamination level. However, there is a large possibility that scuffs (caused for example by a pen) on the display screen 11 may not cleared by the cleaning mode. There may be applied for example an effective configuration in which the control unit 3 does not reset the number of contacts with the pen and the average contact pressure with the pen.

In Step S104, the control unit 3 judges as whether or not the contact as detected by the contact detection device 12 has been made on the basis of an operational instruction on switching the image as displayed during the slide show. In the case where the contact has not been made on the basis of the operational instruction on switching the image (NO in Step S104), the control unit 3 causes the system to move to Step S105. In the case where the contact has been made on the basis of the operational instruction on switching the image as displayed (YES in Step S104), the control unit 3 causes the system to move to Step S108.

In Step S105, the control unit 3 judges as whether or not the contact as detected by the contact detection device 12 has been made on the basis of the other operational instruction. In the case where the contact has been made on the basis of the other operational instruction (YES in Step S105), the control unit 3 causes the system to move to Step S106 to execute the processing based on the other operational instruction and then to move to Step S108. In the case where the contact has not been made on the basis of the other operational instruction (NO in Step S104), the control unit 3 causes the system to move to Step S109.

In Step S107, the control unit 3 judges as whether or not an automatic switching of the displayed image in the slide show has been detected. In the case where the automatic switching of the displayed image has been detected (e.g., an image switching time as set through a timer has come) (YES in Step S107), the control unit 3 causes the system to move to Step S108. In the case where the automatic switching of the displayed image has not been detected (NO in Step S107), the control unit 3 causes the system to move to Step S109.

In Step S109, the control unit 3 judges as whether or not the processing is to be ended. In the case where it is judged that the processing is not to be ended (NO in Step S109), the control unit 3 causes the system to return to Step S100. In the case where it is judged that the processing is to be ended (e.g., the user has given an end instruction) (YES in Step S109), the control unit 3 causes the system to end the processing as shown in FIG. 6.

In Step S108, the control unit 3 executes the display mode determination processing for the image to be displayed on the display screen 11 after the switching as described above. Concerning the examples of this display mode determination processing, Examples 1 to 5 will be described below.

### Example No. 1

In Example No. 1, the position for display of the characteristic portion of the image is shifted to a position on the display screen 11, in which the contamination level is equal to or less than the threshold.

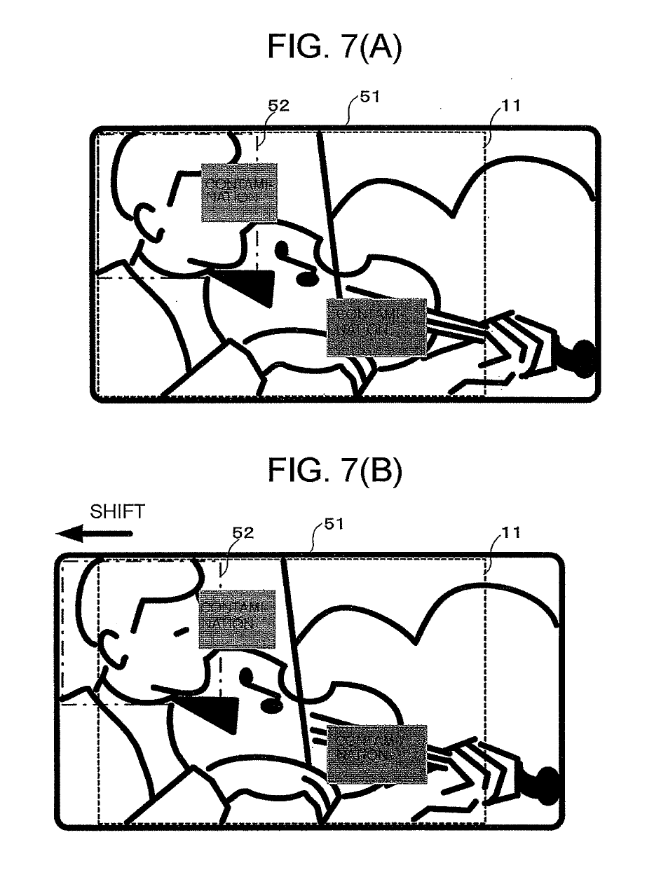

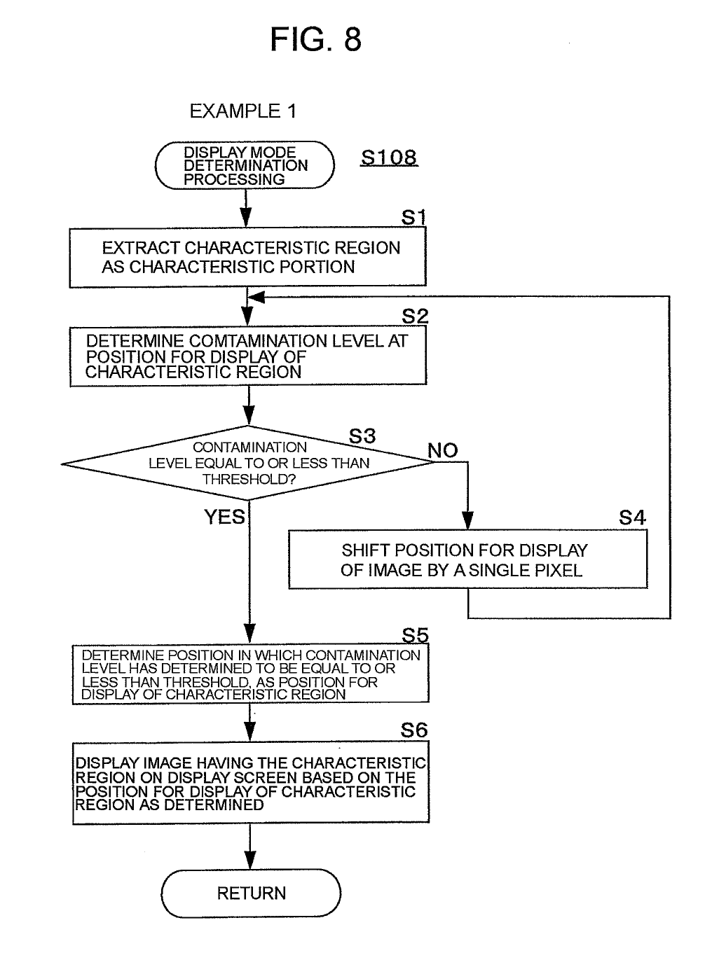

When the processing as shown in FIG. 8 is started, the control unit 3 causes the image data of the image to be displayed on the display screen 11 to be read out in a predetermined region of a RAM, a characteristic region 52 to be extracted as the characteristic portion of this image 51 as shown in FIG. 7(A), and causes coordinates corresponding to the respective pixels (included) in the characteristic region 52 as extracted, to be stored. The coordinates of the respective pixels for the image 51 on the display screen 11 have been set as the initial position. A region surrounded by short dashed lines as shown in FIG. 7(A) corresponds to the display screen 11, and in this example, the size of the image 51 is larger than the size of the display screen 11.

Then, the control unit 3 acquires the contact information for the respective pixels (included) in the characteristic region 52 as extracted, from the contact information database 21 and then determines the contamination level at the position for display of the above-mentioned characteristic region (i.e., the display position on the display screen 11 (the range of display)) based on the contact information as acquired (Step S2). The control unit 3 determines for example the contamination level for the respective pixels from the contact information, which correspond to the respective pixels in the characteristic region 52, and then determines the sum of the contamination levels of the respective pixels as determined, as the contamination level at the position for display of the above-described characteristic region 52. This makes it possible to determine effectively the contamination level for the characteristic region to be displayed at the positions of the display screen.

Then, the control unit 3 judges as whether or not the contamination level at the position for display of the characteristic region 52 as determined is equal to or less than a threshold (e.g., 100) (Step S3). In the case where the contamination level is not equal to or less than the threshold (is for example 110) (NO in Step S3), the system moves to Step S4. In the case where the contamination level is equal to or less than the threshold (YES in Step S3), the system moves to Step S5. There may be applied a configuration in which the control unit 3 acquires a temperature information measured by a thermometer or a humidity information measured by a hygrometer and changes the above-mentioned threshold based on the temperature or humidity at the present time.

In Step S4, the control unit 3 causes the position for display of the image 51 to shift in a vertical, horizontal or oblique direction by a single pixel (by adding a value corresponding to an amount of shift to the coordinates of the respective pixel or subtracting the value from the coordinates). The control unit 3 compares the size of the image 51 with the size of the display screen 11 and then makes a preferential selection of the direction providing a sufficient space (the shift does not cause any blank space). The control unit 3 causes the system to return to Step S2 to determine again the contamination level at the position, after shift, for display of the characteristic region 52, and judge as whether or not the contamination level is equal to or less than the threshold.

Steps S2 to S4 are repeated till the contamination level at the position for display of the characteristic region 52 is judged as being equal to or less than the threshold (e.g., 100) (However, the predetermined number of steps as repeated causes the system to move to Step S5). More specifically, the control unit 3 retrieves the position on the display screen 11, in which the contamination level is equal to or less than the threshold, while moving the position for display of the above-mentioned characteristic region 52 by a single pixel. In these steps as repeated, shift by the single pixel in Step S4 is made so as to shift gradually the position from the initial position of the characteristic region 52. This makes it possible to retrieve correctly the position for display, in which the amount of shift of the image 51 is minimum and the contamination level is equal to or less than the threshold, as shown in FIG. 7(B). The contamination may exist on the characteristic region 52 as shown in FIG. 7(B).

In Step S5, the control unit 3 determines the position in which the contamination level at the position for display of the characteristic region 52 is judged to be equal to or less than the threshold, as the position for display of the above-mentioned characteristic region 52 on the display screen 11. In the example as shown in FIG. 7(B), the control unit 3 changes the position for display of the characteristic region 52 to the position in which a distance from the initial position of the characteristic region 52 (the position for display of the characteristic region 52 in which the contamination level is judged not to be equal to or less than the threshold in FIG. 7(A)) to the position on the display screen 11, in which the contamination level is judged to be equal to or less than the threshold are kept minimum. In the case where there is no change in position for display, the position for display of the characteristic region 52 is determined as the initial position.

The amount of shift of the image 51 may be weighted and limitation to the range of shift may be made. In case of such a limitation, the control unit 3 determines the contamination level at all the positions for display of the characteristic region 52 in the movable region and then determines the position of them, in which the contamination level becomes minimum, as the position for display of the characteristic region 52.

Then, the control unit 3 causes the image 51 having the characteristic region 52 to be displayed at the position for display of the characteristic region 52, as determined (Step S6) and then the system moves to the processing as shown in FIG. 6.

According to Example No. 1, it is possible to automatically shift the position for display of the characteristic region 52 of the image 51 to the position in which the contamination level is equal to or less than the threshold, even when the large contamination having the higher contamination level than the threshold exists in the position at which the characteristic region 52 of the image 51 is to be initially displayed. In addition, the characteristic region 52 can be displayed at the position for display in which the amount of shift of the image 51 is kept minimum and the contamination level is equal to or less than the threshold, thus leading to an effective improvement in visibility of the characteristic region 52 of the image 51, without remarkably changing the position for display at which the image 51 is to be initially displayed.

### Example No. 2

In Example No. 2, the position for display of the characteristic portion of the image is shifted to a block on the display screen 11, in which the contamination level is equal to or less than the threshold.

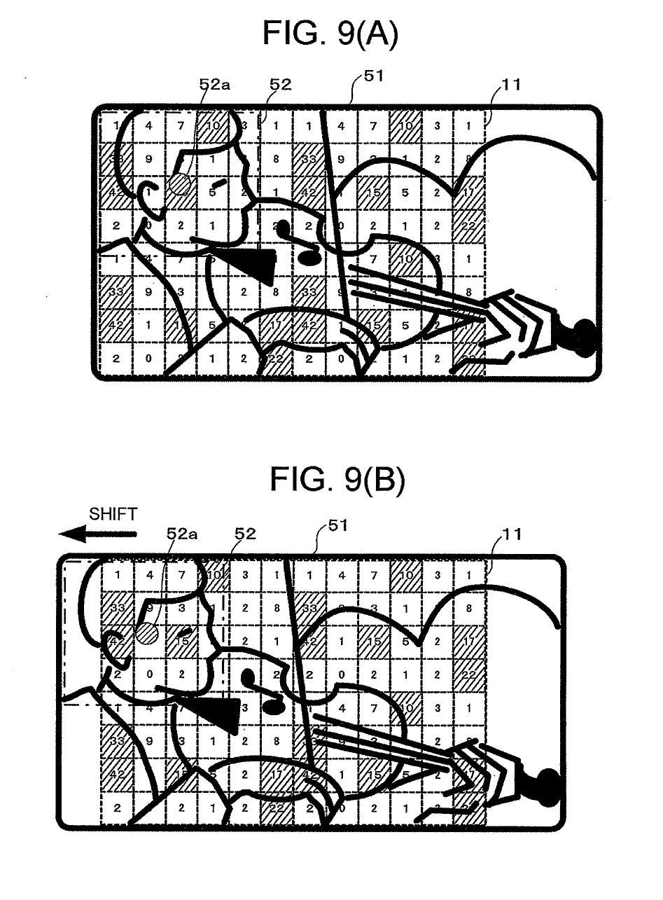

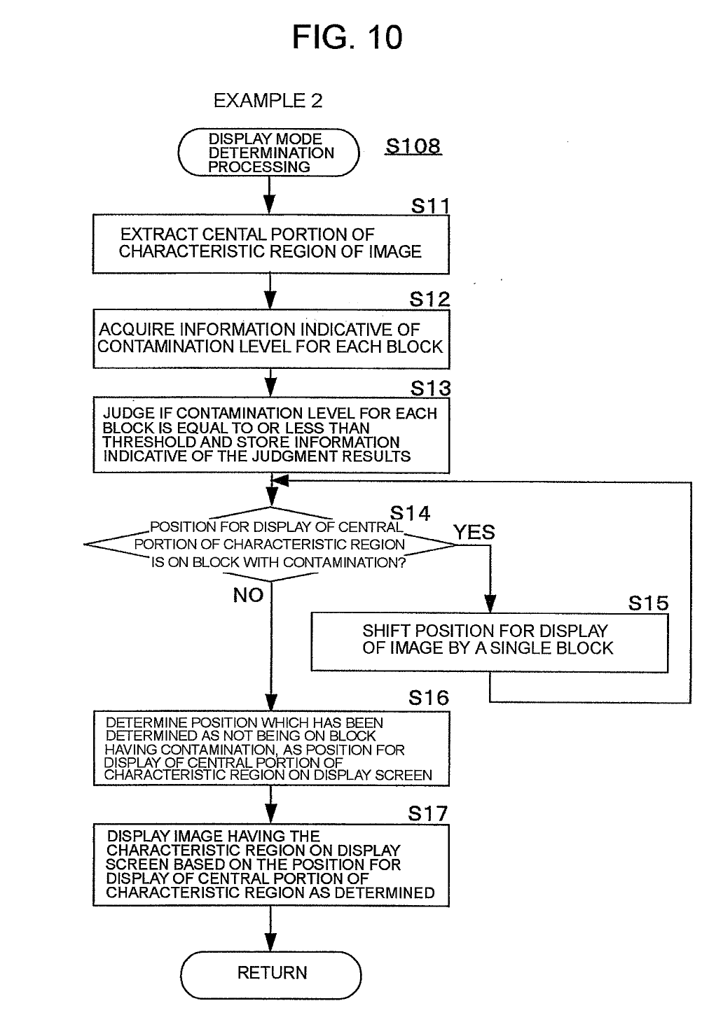

When the processing as shown in FIG. 10 is started, the control unit 3 causes the image data of the image to be displayed on the display screen 11 to be read out in a predetermined region of a RAM, the central portion 52a of a characteristic region 52 to be extracted as the characteristic portion of this image 51 as shown in FIG. 9(A), and coordinates (e.g., the central coordinates) corresponding to the pixel of the central portion 52a as extracted, to be stored.

Then, the control unit 3 acquires the information indicative of the contamination levels of the respective blocks into which the display screen 11 is divided (Step S12). The contamination levels of the respective blocks may be determined by the control unit 3 in Step S12, or information indicative of the contamination levels of the respective blocks, which are previously determined and stored in the storage unit 2, may be acquired.

Then, the control unit 3 judges as whether or not the contamination levels of the respective blocks are equal to or less than the threshold (Step S13) and causes the information indicative of the judgment results to be stored. In the example as shown in FIG. 9(A), hatched blocks show blocks in which the contamination level is higher than the threshold (, which is “9” in this example) (hereinafter referred to as the “contaminated blocks”).

The control unit 3 judges from the coordinates as whether or not the position for display of the central portion 52a of the characteristic region 52 as extracted is placed on the contaminated block (including a the case where it is placed on the boundary between the contaminated block and the other block) (Step S14). In the case where it is placed on the contaminated block (YES in Step S14), the system moves to Step S15. In the case where it is not placed on the contaminated block (NO in Step S14), the system moves to Step S16.

In Step S15, the control unit 3 causes the position for display of the image 51 to shift in a vertical, horizontal or oblique direction by a single block. The control unit 3 compares the size of the image 51 with the size of the display screen 11 and then makes a preferential selection of the direction providing a sufficient space (the shift does not cause any blank space). The control unit 3 causes the system to return to Step S14 to judge as whether or not the position for display of the central portion 52a of the characteristic region 52 after shift is placed on the contaminated block.

Steps S14 and S15 are repeated till the position for display of the central portion 52a of the characteristic region 52 is judged as not being placed on the contaminated block (However, the predetermined number of steps as repeated caused the system to move to Step S16). More specifically, the control unit 3 retrieves the block on the display screen 11, in which the contamination level is equal to or less than the threshold (i.e., the non-contaminated block), while moving the position for display of the above-mentioned characteristic region 52 by a single block. In these steps as repeated, shift by the single block in Step S15 is made so as to shift gradually the position from the initial position of the central portion 52a of the characteristic region 52. This makes it possible to retrieve correctly the position for display, in which the amount of shift of the image 51 is minimum and the contamination level is equal to or less than the threshold, as shown in FIG. 9(B).

In Step S16, the control unit 3 determines the position in which the position for display of the central portion 52a of the characteristic region 52 is judged as not being placed on the contaminated block, as the position for display of the central portion 52a of the above-mentioned characteristic region 52 on the display screen 11. More specifically, the control unit 3 determines the display mode so that the central portion 52a of the characteristic region 52 is placed on the non-contaminated block whose contamination level is judged to be equal to or less than the threshold. In the example as shown in FIG. 9(B), the position for display of the central portion 52a of the characteristic region 52 is changed from the initial position for the central portion 52a of the characteristic region 52 (i.e., the position for display on the contaminated block in which the contamination level is judged not to be equal to or less than the threshold as shown in FIG. 9(A)) to the position on the non-contaminated block in which the contamination level is judged to be equal to or less than the threshold. In the case where there is no change in position for display, the position for display of the central portion 52a of the characteristic region 52 is determined as the initial position.

The amount of shift of the image 51 may be weighted and limitation to the range of shift may be made in the same manner as Example No. 1. In case of such a limitation, the control unit 3 determines the block whose contamination level is kept minimum, in the plurality of blocks included in the movable range, as the position for display of the central portion 52a of the characteristic region 52.

Then, the control unit 3 causes the image 51 having the characteristic region 52 to be displayed on the display screen 11, based on the position for display of the central portion 52a of the above-mentioned characteristic region 52, as determined (Step S17), and the system to return to the processing as shown in FIG. 6.

According to Example No. 2, it is possible to control the contamination level for each of the blocks so that the central portion 52a of the characteristic region 52 of the image 51 can be displayed effectively at the position of the relatively clean block in which the contamination level is equal to or less than the threshold. In addition, even when the position for display of the central portion 52a of the characteristic region 52 of the image 51, at which the image is to be initially displayed has a large contamination level that is higher than the threshold, it is possible to automatically shift the position for display of the central portion 52a of the characteristic region 52 of the image 51 to the relatively clear position in which the contamination level is equal to or less than the threshold.

Example No. 2 is described as to provide a configuration in which the central portion 52a of the characteristic region 52 of the image 51 is extracted and the position for display of the above-mentioned central portion 52a is changed. However, there may be applied a configuration in which the characteristic region 52 of the image 51 is extracted and the position for display of the above-mentioned characteristic portion 52 to a position on the non-contaminated block in which the contamination level is equal to or less than the threshold.

### Example No. 3

In Example No. 3, the position for display of the characteristic portion of the image is shifted to a continuous block region on the display screen 11, in which the contamination level is equal to or less than the threshold.

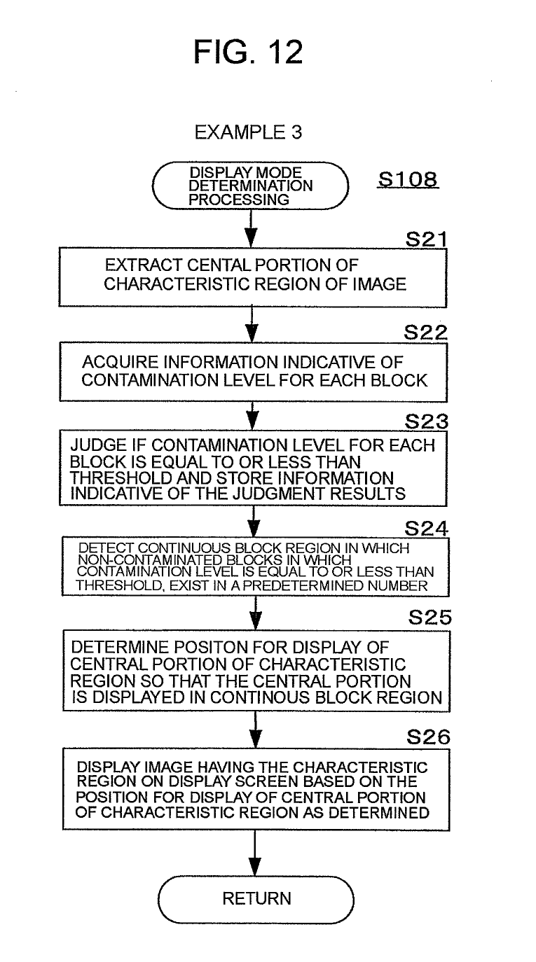

Steps S21-S23 and S26 as shown in FIG. 12 are the same as Step S11-S13 and S17 as shown in FIG. 10, and the description of these step will be omitted.

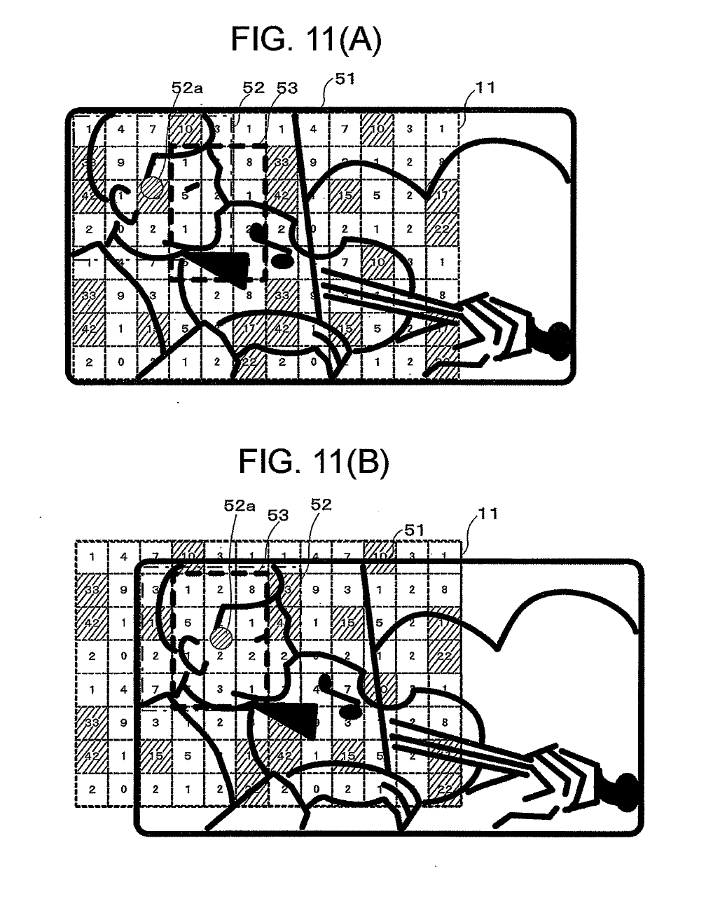

In Step S24, the control unit 3 causes a continuous block region 53 in which the predetermined number (e.g., two or more blocks in the X direction and two or more blocks in the Y direction) of non-contaminated blocks whose contamination level is equal to or less than the threshold continuously exist as shown in FIG. 11(A) to be detected. In the case where a plurality of continuous block regions is detected, the continuous block region having the largest area of these regions may be detected, or the continuous block region, which is the nearest to the coordinates of the central portion 52a of the characteristic region as extracted, may be detected.

Then, the control unit 3 determines the position for display of the above-mentioned central portion 52a so that the central portion 52a of the characteristic region 52 is displayed within the continuous block region 53 as detected (Step S25). In the example as shown in FIG. 11(B), the position for display of the central portion 52a of the characteristic region 52 is placed in the central position of the continuous block region.

According to Example No. 3, it is possible to display effectively the central portion 52a of the characteristic region 52 of the image 51 within the continuous block region 53 in which the contamination level is equal to or less than the threshold.

Example No. 3 is described as to provide a configuration in which the central portion 52a of the characteristic region 52 of the image 51 is extracted and the position for display of the above-mentioned central portion 52a is changed. However, there may be applied a configuration in which the characteristic region 52 of the image 51 is extracted and the position for display of the above-mentioned characteristic region 52 is changed to be placed within the continuous block region 53.

### Example No. 4

In Example No. 4, the positions for display of the plurality of characteristic portions are shifted to a block on the display screen 11, in which the contamination level is equal to or less than the threshold.

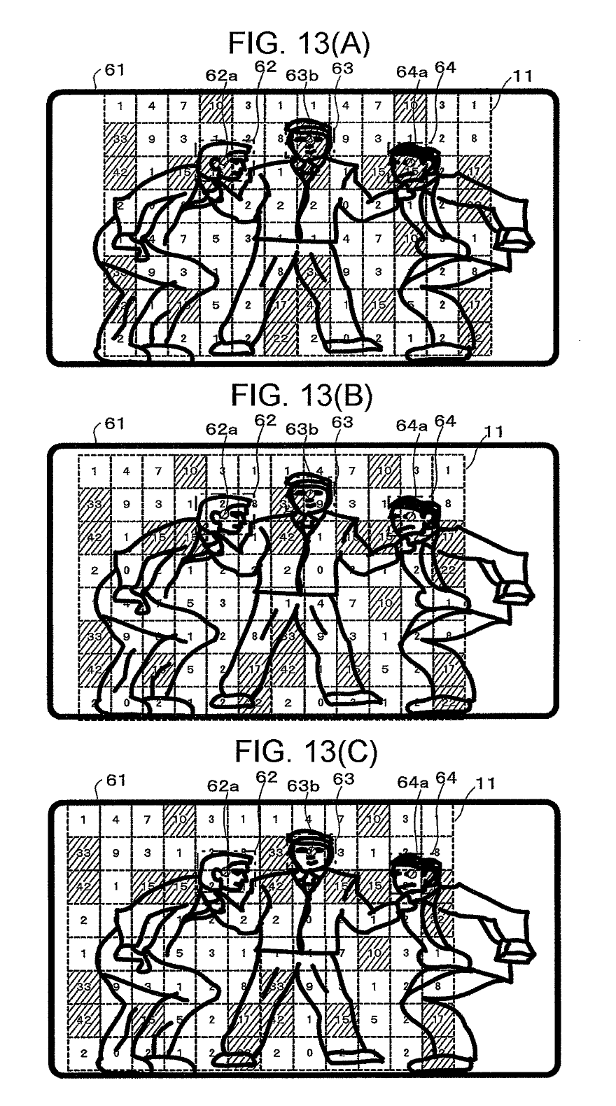

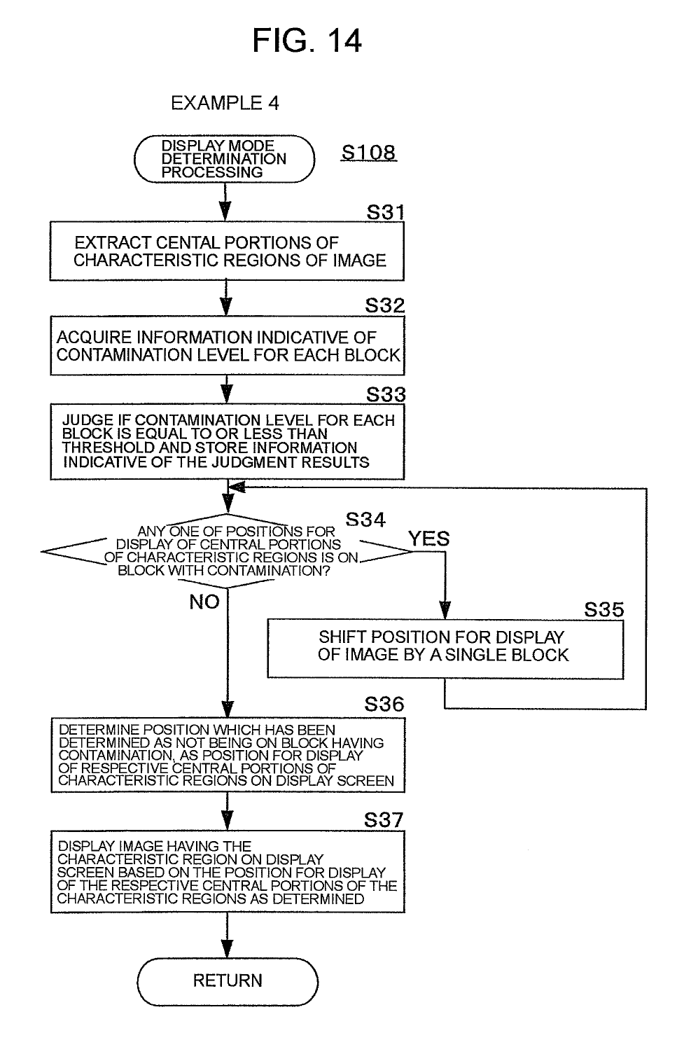

When the processing as shown in FIG. 14 is started, the control unit 3 causes the image data of the image to be displayed on the display screen 11 to be read out in a predetermined region of a RAM, causes the central portions 62a, 63a, 64a of the plurality of characteristic regions 62, 63, 64 (i.e., three characteristic regions in the example as shown in FIG. 13(A)) to be extracted (Step S31) and causes coordinates (e.g., the central coordinates) corresponding to the pixels of the respective central portions 62a, 63a, 64a as extracted, to be stored.

Steps S32, S33 and S37 as shown in FIG. 14 are the same as Step S12, S13 and S17 as shown in FIG. 10, and the description of these step will be omitted.

In Step S34, the control unit 3 judges as whether or not the positions for display of the respective central portions 62a, 63a, 64a of the plurality of characteristic regions 62, 63, 64 as extracted are placed on the contaminated block. In the case where the position for display of any one of the central portions 62a, 63a, 64a is placed on the contaminated block (YES in Step S34), the system moves to Step S35. In the case where any one of the positions for display of the central portions 62a, 63a, 64a is not placed on the contaminated block (NO in Step S34), the system moves to Step S36.

Then, the control unit 3 causes the position for display of the image 61 to shift in a vertical, horizontal or oblique direction by a single block in the same manner as Step S15 in Example No. 2. The control unit 3 causes the system to move to Step S34 to judge as whether or not the positions, after shift, for display of the respective central portions 62a, 63a, 64a of the characteristic regions 62, 63, 64 are placed on the contaminated block. Steps S34 and S35 are repeated till the positions for display of all the central portions 62a, 63a, 64a are judges as not being placed on the contaminated block (However, the predetermined number of steps as repeated causes the system to move to Step S5).

In Step S36, the control unit 3 determines the positions for display of the above-mentioned central portions 62a, 63a, 64a so that the respective central portions 62a, 63a, 64a of the characteristic regions 62, 63, 64 are displayed at the position on the non-contaminated block, whose contamination level has been judged as being equal to or less than the threshold. In the example as shown in FIG. 13(B), the positions for display of the respective central portions 62a, 63a, 64a have been shifted from the initial positions for the respective central portions 62a, 63a, 64a of the characteristic regions 62, 63, 64 (as shown in FIG. (A)) to the positions on the non-contaminated block, whose contamination level has been judged as being equal to or less than the threshold.

Example No. 4 is described as to provide a configuration in which the central portions 62a, 63a, 64a of the plurality of characteristic regions 62, 63, 64 of the image 61 are extracted and the positions for display of the respective central portions 62a, 63a, 64a are shifted. However, there may be applied a configuration in which the plurality of characteristic regions 62, 63, 64 of the image 61 are extracted and the positions for display of the respective central portions 62a, 63a, 64a are shifted to positions on the non-contaminated block whose contamination level has been judged as being equal to or less than the threshold.

In the other example of this case, there may be applied a configuration in which the control unit 3 causes the largest characteristic region having the largest area (corresponding to the characteristic region 62 in the example as shown in FIG. 13(A)) to be detected from the plurality of characteristic regions 62, 63, 64 as extracted in the above-described Step S31, and causes coordinates corresponding to the pixels (included) in the largest characteristic region 62 as detected, to be stored.

In such a configuration case, the control unit 3 judges as whether or not the position for display of the largest characteristic region 62 as detected is placed on the contaminated block in the above-described Step S34. In the case where the position for display of the above-mentioned largest characteristic region 62 is placed on the contaminated block (YES in Step S34), the system moves to Step S35. In the case where the position for display of the above-mentioned largest characteristic region 62 is not placed on the contaminated block (NO in Step S34), the system moves to Step S36.

Then, the control unit 3 causes the image 61 to shift in a vertical, horizontal or oblique direction by a single block, and causes the system to move to Step S34 to judge as whether or not the position, after shift, for display of the largest characteristic region 62 is placed on the contaminated block.

The control unit 3 determines, in Step S36, the position for display of the above-mentioned largest characteristic region 62 so that the largest characteristic region 62 is displayed at the position on the non-contaminated block whose contamination level has been judged as being equal to or less than the threshold. In the example as shown in FIG. 13(C), the position for display of the largest characteristic region 62 is changed from the initial position for the largest characteristic region 62 (as shown in FIG. 13(A)) to the position on the non-contaminated block whose contamination level has been judged as being equal to or less than the threshold.

According to Example No. 4, if the plurality of characteristic portions is extracted from the image, it is possible to display all the characteristic portions at the positions on the block whose contamination level is equal to or less than the threshold. In addition, if the plurality of characteristic regions is extracted from the image, it is possible to display the largest characteristic region having the largest area of the plurality of characteristic regions at the position on the block whose contamination level is equal to or less than the threshold.

### Example No. 5

In Example No. 5, the image is turned, enlarged or reduced so that the characteristic portion is displayed at the position on the display screen 11, whose contamination level is equal to or less than the threshold.

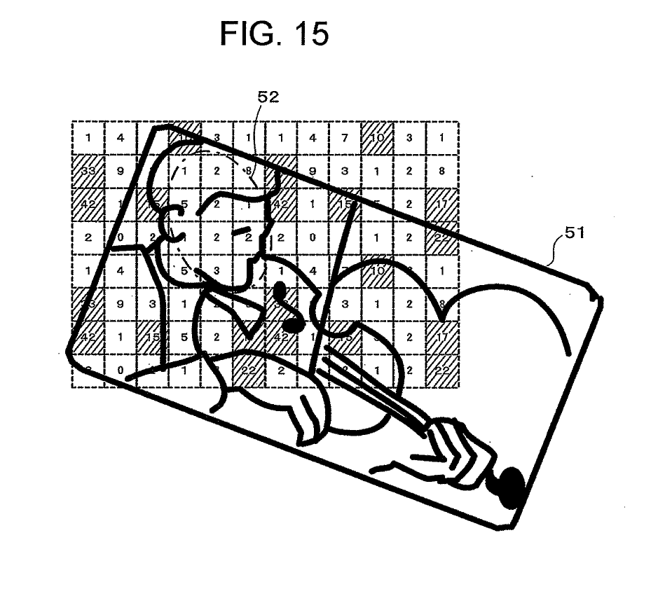

The turning, enlarging or reducing of the image may be conducted in the processing described in Examples Nos. 1 to 4 as described above. In for example in Step S15 in Example No. 2, the control unit 3 causes the image 51 to turn, in stead of shifting the position for display of the image or while shifting the position thereof (for example, after shift of the position), by a predetermined angle as shown in FIG. 15 and a coordinate calculation to be made, till the position for display of the characteristic region (which may be a central portion of the characteristic region) is judged as not being placed on the contaminated block. There is a limitation on a turning angle as set (as ±45 degrees) and the turning operation of the image is carried out in the range of this turning angle. The control unit 3 determines a turning angle based on which the image including the characteristic region 52 is to be turned so that the position for display of the characteristic region 52 is placed within the region on the non-contaminated block as shown in FIG. 15 (namely, so that the contaminated block does not exist at the position for display of the characteristic region 52).

There may be applied to a configuration in which the control unit 3 causes in Step S15 the image to be reduced, in stead of shifting the position for display of the image or while shifting the position thereof (for example, after shift of the position), by a predetermined magnification and a coordinate calculation to be made, till the position for display of the characteristic region is judged as not being placed on the contaminated block. There is set the lower limit of the magnification of reduction and the reduction of the image is conducted based on the range of magnification of reduction, whose lower limit is set in this manner. The control unit 3 determines the magnification, based on which the image including the characteristic region is to be reduced so that the characteristic region fits into the region within the non-contaminated block in this manner. This permits to reduce the image to at least the size of the display screen 11, thus being effective especially in the case where the size of the image is larger than the size of the display screen 11. There may be applied a configuration in which the image is turned and reduced so that the characteristic region fits within the region on the non-contaminated block.

In the case where the size of the image is smaller than the size of the display screen 11 and there is a large number of non-contaminated blocks, there may be applied a configuration in which the control unit 3 causes the image to be enlarged, in stead of shifting the position for display of the image or while shifting the position thereof (for example, after shift of the position), by a predetermined magnification and a coordinate calculation to be made, till the position for display of the characteristic region is judged as not being placed on the contaminated block. There is set the upper limit of the magnification of enlargement and the enlargement of the image is conducted based on the range of magnification of enlargement, whose upper limit is set in this manner (in an example case, the upper limit of magnification of enlargement is set so as to enlarge the image to the size of the display screen 11).

According to Example No. 5, it is possible to display effectively the image by turning, enlarging or reducing the image so that the characteristic portion of the image is placed within the region on the display screen 11, whose contamination level is equal to or less than the threshold.

According to the embodiments of the present invention as described above, the display apparatus with touch panel “S” previously acquires the contact information containing information about the contact action detected by the contact detection section 12, which is disposed on the display screen 11 to detect the contact action, and information about the contact position on the display screen 11, and stores the same, and then determines the contamination level at the plurality of positions on the display screen 11 based on the above-mentioned contact information. The display apparatus with touch panel “S” has the configuration to extract the characteristic portion of the image to be displayed and determine the display mode for the characteristic portion as extracted, based on the contamination level as determined. It is therefore possible to improve visibility of the characteristic portion of the image to be displayed on the display screen 11 and enable a user to use it in a comfortable manner for a long period of time, even when the display screen 11 is contaminated.

### DESCRIPTION OF REFERENCE NUMERALS

1 touch panel display
2 storage unit
3 control unit
11 display screen
12 contact detection section
21 contact information database
S display apparatus with touch panel

What is claimed is:

1. A display apparatus comprising: a display screen on which an image is to displayed, and a contact detection device disposed on the display screen to detect a contact action, wherein:
said display apparatus further comprises:
a contact information storage device that stores contact information comprising information about the contact action detected by said contact detection device and information about a position on said display screen;
a contamination level determination device that determines a contamination level at a plurality of positions on said display screen, based on the contact information stored in said contact information storage device;
an image characteristic portion extraction device that extracts a characteristic portion of said image; and
a display mode determination device that determines a display mode for the characteristic portion extracted by said image characteristic extraction device, based on the contamination level at the plurality of positions on said display screen, which has been determined by said contamination level determination device.

2. The display apparatus as claimed in claim 1, wherein:
said contamination level determination device determines said contamination level at the position of display of said characteristic portion on said display screen;
said display apparatus further comprises:
a threshold judgment device that judges as to whether or not said contamination level at the position for display of said characteristic portion, which has been determined by said contamination level determination device, is equal to or less than a threshold, and
wherein:
said display mode determination device changes, in a case where said threshold judgment device judges that the contamination level at the position for display of said characteristic portion is not equal to or less than the threshold, the position for display of said characteristic portion to a position on said display screen, in which said contamination level is judged to be equal to or less than the threshold.

3. The display apparatus as claimed in claim 2, wherein:
said image characteristic portion extraction device extracts, as said characteristic portion, a characteristic region, which comprises a plurality of pixels; and
said contamination level determination device determines said contamination level at the position for display of said characteristic region, based on said contact information per pixel in said characteristic region.

4. The display apparatus as claimed in claim 3, further comprising:
a retrieval device that retrieves, in a case where said threshold judgment device judges that the contamination level at the position for display of said characteristic region is not equal to or less than the threshold, the position on said display screen, in which said contamination level is equal to or less than the threshold, while moving the position for display of said characteristic region by a single pixel unit.

5. The display apparatus as claimed in claim 2, wherein:
said display mode determination device changes the position for display of said characteristic portion to a position where a distance between the position for display of said characteristic portion, in which the contamination level at the position for display of said characteristic region has been judged to be not equal to or less than the threshold by said threshold judgment device, and the position on said display screen, in which the contamination level has been judged to be equal to or less than the threshold becomes minimum.

6. The display apparatus as claimed in claim 1, wherein:
said contamination level determination device determines, in a unit of blocks into which said display screen is divided, the contamination level at the plurality of positions including the position of display of said characteristic portion on said display screen;
said display apparatus further comprises:
a contamination level storage device that stores said contamination level as determined in each of said blocks; and
a threshold judgment device that judges as to whether or not the contamination level in each of the blocks stored in said contamination level storage device, is equal to or less than a threshold, and
wherein:
said display mode determination device determines the display mode for the characteristic portion so that said characteristic portion is displayed at a position in the block in which the contamination level has been judged to be equal to or less than the threshold by said threshold judgment device.

7. The display apparatus as claimed in claim 6, wherein:
said image characteristic portion extraction device extracts, as said characteristic portion, a central portion of a characteristic region, which comprises a plurality of pixels; and
said display mode determination device changes, in a case where said threshold judgment device judges that the contamination level in said block at the position for display of the central portion of said characteristic region is not equal to or less than the threshold, the position for display of the central portion of said characteristic region to a position in said block, in which said contamination level is judged to be equal to or less than the threshold.

8. The display apparatus as claimed in claim 6, wherein:
said image characteristic portion extraction device extracts, as said characteristic portion, a characteristic region, which comprises a plurality of pixels; and
said display mode determination device changes, in a case where said threshold judgment device judges that the contamination level in said block at the position for display of said characteristic region is not equal to or less than the threshold, the position for display of said characteristic region to a position in said block, in which said contamination level is judged to be equal to or less than the threshold.

9. The display apparatus as claimed in claim 7, further comprising:
a continuous-blocks region detection device that detects a continuous-blocks region in which there continuously exist the blocks having the contamination level that is equal to or less than the threshold; and
wherein:
said display mode determination device determines the position for display of the characteristic portion so that said characteristic portion is displayed in the continuous-blocks region detected by said continuous-blocks region detection device.

10. The display apparatus as claimed in claim 8, wherein:
said image characteristic portion extraction device extracts the characteristic portion as a plurality of characteristic regions; and
said display apparatus further comprises:
a largest-characteristic region detection device that detects a largest characteristic region having a largest area of the plurality of characteristic regions as extracted by said image characteristic portion extraction device; and
wherein:
said display mode determination device determines the display mode for said largest characteristic region so that said largest characteristic region is displayed at a position in the block in which the contamination level has been judged to be equal to or less than the threshold by said threshold judgment device.

11. The display apparatus as claimed in claim 1, further comprising:
a threshold judgment device that judges as to whether or not said contamination level, which has been determined by said contamination level determination device, is equal to or less than a threshold; and
a region detection device that detects a region on said display screen, in which said contamination level is equal to or less than the threshold; and
wherein:
said display mode determination device determines a magnification, based on which the image including said characteristic portion is to be enlarged or reduced so that said characteristic portion fits into said region detected by said region detection device.

12. The display apparatus as claimed in claim 11, wherein:
said display mode determination device changes a position for display of said characteristic portion to a position on said display screen, in which the contamination level has been judged to be equal to or less than the threshold by said threshold judgment device, and determines the magnification, based on which the image including said characteristic portion is to be enlarged or reduced so that said characteristic portion fits into said region detected by said region detection device.

13. The display apparatus as claimed in claim 1, further comprising:
a threshold judgment device that judges as to whether or not said contamination level, which has been determined by said contamination level determination device, is equal to or less than a threshold; and
a region detection device that detects a region on said display screen, in which said contamination level is equal to or less than the threshold; and
wherein:
said display mode determination device determines a turning angle, based on which the image including said characteristic portion is to be turned so that said characteristic portion fits into said region detected by said region detection device.

14. The display apparatus as claimed in claim 13, wherein:
said display mode determination device changes a position for display of said characteristic portion to a position on said display screen, in which the contamination level has been judged to be equal to or less than the threshold by said threshold judgment device, and determines the turning angle, based on which the image including said characteristic portion is to be turned so that said characteristic portion fits into said region detected by said region detection device.

15. The display apparatus as claimed in claim 1, further comprising:
a contact object kind recognition device that recognizes a kind of a contact object detected by said contact detection device; and
a weighting determination device that determines weighted values of the contamination levels at the plurality of positions on said display screen, based on the kind of the contact object, recognized by said contact object kind recognition device; and
wherein:
said contamination level determination device determines the contamination level at the plurality of positions on said display screen, based on the weighted values determined by said weighting determination device.

16. The display apparatus as claimed in claim 1, further comprising:
a distance calculation device that calculates a value corresponding to a distance between the position for display of said characteristic portion on said display screen and a position for display of a thing other than said characteristic portion on said display screen; and
a weighting determination device that determines weighted values of contamination level at the plurality of positions for a thing other than said characteristic portion on said display screen, based on the value corresponding to the distance, calculated by said distance calculation device; and
wherein:
said contamination level determination device determines the contamination level at the plurality of positions on said display screen, based on the weighted values determined by said weighting determination device.

17. The display apparatus as claimed in claim 1, further comprising:
a cleaning mode detection device that detects a cleaning mode for cleaning said display screen; and
a contamination initialization device that initializes, in a case where said cleaning mode detection device has detected the cleaning mode, said contact information or said contamination level determined by said contamination level determination device.

18. The display apparatus as claimed in claim 1, wherein:
the information about said contact action detected by said contact detection device comprises at least one of a number of contacts and a contact pressure.

19. A method for determining a display mode in a display apparatus comprising a display screen on which an image is to displayed, and a contact detection device disposed on the display screen to detect a contact action, said method comprising the steps of:
storing contact information comprising information about the contact action detected by said contact detection device and information about a position on said display screen;
determining a contamination level at a plurality of positions on said display screen, based on the contact information as stored;
extracting a characteristic portion of said image; and
determining a display mode for the characteristic portion as extracted, based on the contamination level as determined at the plurality of positions on said display screen.

20. A recording medium in which there is recorded a display processing program, which is to be executed by a computer comprising a display screen on which an image is to displayed, and a contact detection device disposed on the display screen to detect a contact action, to cause the computer to function as:
a contact information storage device that stores contact information comprising information about the contact action detected by said contact detection device and information about a position on said display screen;
a contamination level determination device that determines a contamination level at a plurality of positions on said display screen, based on the contact information stored in said contact information storage device;
an image characteristic portion extraction device that extracts a characteristic portion of said image; and
a display mode determination device that determines a display mode for the characteristic portion extracted by said image characteristic extraction device, based on the contamination level at the plurality of positions on said display screen, which has been determined by said contamination level determination device.
